(19) United States
(12) Patent Application Publication
(10) Pub. No.: US 2005/0116090 A1
(43) Pub. Date: Jun. 2, 2005

(54) Non-lethal nose cone design

(76) Inventors: Thomas C. Welty, Big Lake, MN (US); Randy E. Berg, Coon Rapids, MN (US); Thomas D. Fredrickson, St. Paul, MN (US); Richard F. Johnson, Crystal, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/765,571

(22) Filed: Jan. 27, 2004

Related U.S. Application Data
(63) Continuation-in-part of application No. 10/355,541, filed on Jan. 31, 2003.

(51) Int. Cl. B64C 1/00

(52) U.S. Cl. 244/13

(57) ABSTRACT

A non-lethal nose cone adapted for the delivery of non-lethal munitions with a projectile weapon. The non-lethal nose cone is manufactured of materials, such as polymers and ceramics, selected for traits including high strength and uniformity when exposed to typical projectile firing conditions as well as an ability to avoid becoming lethal shrapnel upon detonation of an internal charge for disbursing the non-lethal submunitions through pre-scored grooves on the nose cone. Generally, the non-lethal nose cone is intended for use with a projectile having an integral kinetic energy reduction system that may serve the dual role of assisting with submunition ejection through the pre-scored grooves as well as reducing the fall rate of the projectile to non-lethal velocities. Generally, the non-lethal nose cone is adapted for use with standoff delivery systems such as mortar rounds, air delivery systems and artillery.

### RELATED APPLICATIONS

This application is a continuation-in-part of U.S. patent application Ser. No. 10/355,541 entitled “Projectile Kinetic Energy Reduction System” filed May 6, 2003.

### FIELD OF THE INVENTION

The present invention relates generally to the field of military projectiles. More specifically, the present invention relates to a non-lethal projectile nose cone design adapted for standoff delivery of non-lethal munitions.

### BACKGROUND OF THE INVENTION

In recent years, the role of the military has evolved beyond its traditional battlefield mission. Troops are as likely to be deployed in response to political peacekeeping missions as they are for traditional combat. To accommodate these new missions, military weapons and tactics must evolve and be adapted for use in these new roles.

An example of where new weapons and tactics are necessary is in crowd control of hostile groups of non-combatants in areas under occupation by the military. For both political and safety reasons, the use of lethal force against civilians is allowed only as a last resort, typically only when there is an imminent risk of harm to military personnel. Even when the use of lethal force may be required, the military, political and social repercussions from such force may dissuade a commander from its application. Thus a wide number of traditional military weapons provided to deployed personnel cannot be used for crowd control missions.

Because the use of lethal force in maintaining control and order is obviously a last resort, a number of non-lethal alternatives have been suggested. One commonly suggested alternative includes the firing of non-lethal projectiles directly at targets, typically civilians, using hand-carriable guns or other launchers. While these projectiles can be used effectively, they all suffer the downside of requiring the military personnel to be in close proximity to the targets. As such, the military personnel are exposed to the risk of return fire.

One way to limit the exposure of military personnel to retaliatory attacks is to use currently deployed standoff delivery systems, such as mortars or artillery, to deliver a non-lethal projectile. The use of standoff delivery systems for attacking fixed and mobile targets on the battlefield is well known. The advantage of such systems is that they can be fired from locations removed from the actual battlefield thus eliminating the risk of line of sight return fire. Further, the element of surprise is established by delivering a munition to the target without notice.

Recently, these standoff delivery systems have been adapted to fire non-lethal munitions for use in crowd control or other situations in which the use of lethal force is undesirable. However, even the standoff systems have a downside in that the delivery vehicle itself may create a hazard as it falls to the earth. In conventional applications of a mortar or artillery round, the nose cone is shattered into fragments or shrapnel upon deployment of the payload. Thus there is a need for a standoff system in which both the crowd control munition and the delivery vehicle itself are used without lethal harm.

One non-lethal delivery method is described in U.S. patent application Ser. No. 10/355,541 entitled “Projectile Kinetic Energy Reduction System” which is commonly assigned to the assignee of the present application and is hereby incorporated by reference in it entirety. There remains a need then to insure that the nose cone itself does not become a lethal weapon upon dispersal of its non-lethal cargo.

### SUMMARY OF THE INVENTION

The present invention comprises a non-lethal nose cone adapted for the delivery of non-lethal munitions with a projectile weapon. Generally, the non-lethal nose cone of the present invention is manufactured of materials, such as polymers and ceramics, selected for traits including high strength and uniformity when exposed to typical projectile firing conditions. The material selection avoids the conventional hazards of nose cone design wherein detonation of an internal charge disperses shrapnel. The non-lethal nose cone may also include a planned failure mode so that the nose cone opens in a petal like configuration upon impact of the internal munition.

Generally, the non-lethal nose cone of the present invention is intended for use with a projectile incorporating a projectile kinetic energy reduction system such as described in U.S. patent application Ser. No. 10/355,541 entitled “Projectile Kinetic Energy Reduction System”. The projectile kinetic energy reduction system dramatically reduces the forward momentum of the projectile and then directs the descent at a non-lethal rate. The projectile kinetic energy system serves the dual-functions of assisting with ejection of a submunition through the non-lethal nose cone as well as reducing the fall rate of the projectile structure to non-lethal velocities of approximately less than 11 m/s (24.6 mph).

Generally, the non-lethal nose cone of the present invention is adapted for use with appropriate, standoff delivery systems. In a preferred embodiment, the non-lethal nose cone is configured with standard issue mortar, for example 81 mm and 120 mm mortars. In another embodiment, the non-lethal nose cone is configured for use with air delivery systems, such as projectiles delivered from airplanes or helicopters. In another embodiment, the non-lethal nose cone of the present invention can be adapted for use with standoff delivery systems including land or sea based artillery.

### BRIEF DESCRIPTION OF THE FIGURES

FIG. 1 is a perspective view of an embodiment of a non-lethal nose cone of the present invention.

FIG. 2 is a side view of the non-lethal nose cone of FIG. 1.

FIG. 3 is a side view of the non-lethal nose cone of FIG. 1.

FIG. 4 is an end view of the non-lethal nose cone of FIG. 1.

FIG. 5 is a sectional, side view of the non-lethal nose cone of FIG. 1 attached to a projectile tube.

FIG. 6 is a perspective view of a mortar round including the non-lethal nose cone of FIG. 1.

FIG. 7 is a perspective view of the mortar round of FIG. 6 at time of deployment of a kinetic energy reduction system.

FIG. 8 is a sectional side view of the mortar round of FIG. 6 including a fully deployed kinetic energy reduction system.

FIG. 9 is a sectional side view of the mortar round of FIG. 6 at time of nose cone extension.

FIG. 10 is a perspective view of the mortar round of FIG. 5 at time of deployment of a non-lethal munition.

### DESCRIPTION OF THE INVENTION

The present invention comprises a non-lethal nose cone adapted for the delivery of non-lethal munitions with a projectile weapon. Typical projectile nose cones are constructed to separate into many individual pieces upon a triggering event, with each individual piece having sufficient kinetic energy to cause bodily harm. The present invention provides a design to eliminate the lethal aspect of payload dispersal. Generally, the non-lethal nose cone of the present invention is manufactured of materials, such as polymers and ceramics, selected for traits including high strength and uniformity when exposed to typical projectile firing conditions as well as their ability to avoid becoming lethal shrapnel upon detonation of an internal charge for disbursing the non-lethal munitions through the nose cone.

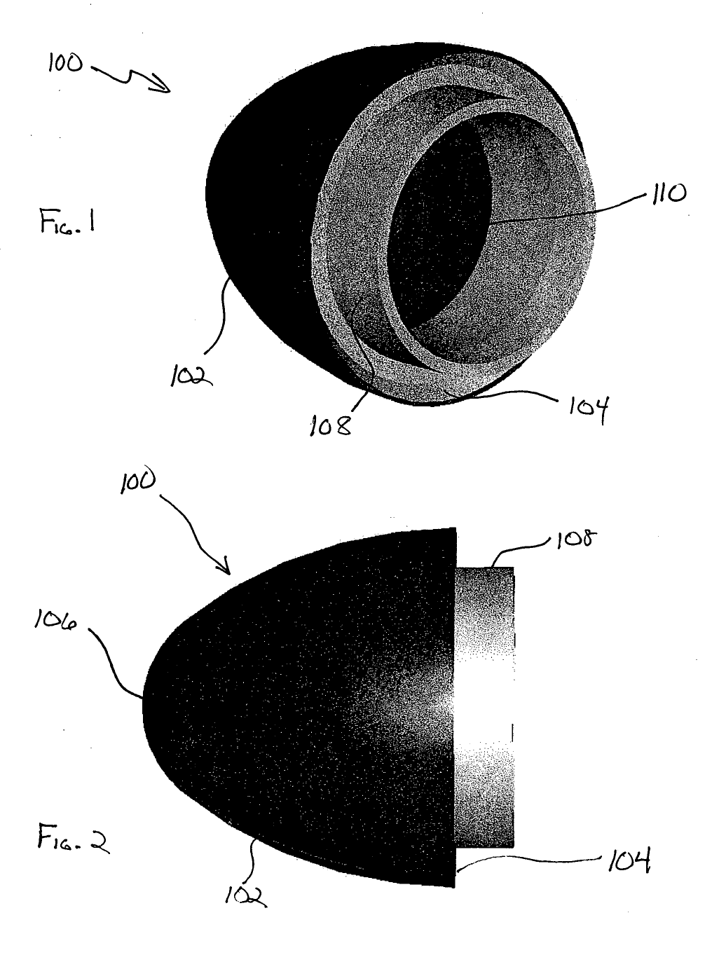

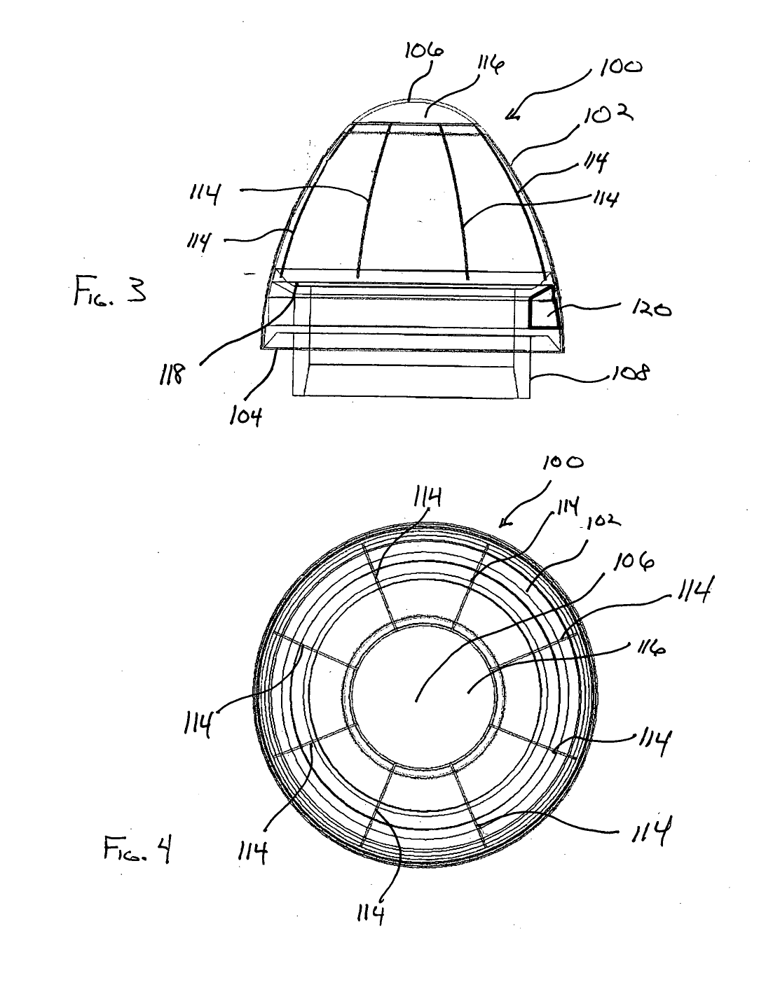

As depicted in FIGS. 1 and 2, a non-lethal nose cone 100 of the present invention comprises a nose cone body 102 having a generally, circular cross-section radiused from an abutment ring 104 to a tip 106. Projecting from abutment ring 104 is an internal projection surface 108. Nose cone body 102 is generally hollow and defines an internal nose cone volume 110. Typically, internal nose cone volume 110 is sized to accommodate an electronic payload control 112. In addition, molded within internal nose cone volume 110 is a circumferential fuse circuit cavity 120 for placement of a fuse device.

Generally, nose cone 100 is comprised of a polymeric or ceramic material selected for its ability to withstand launch induced stresses while also limiting the potential for the creation of shrapnel during a munition deployment. For example, nose cone 100 can be comprised of polymeric materials including polycarbonate, polyethylene, polypropylene and nylon.

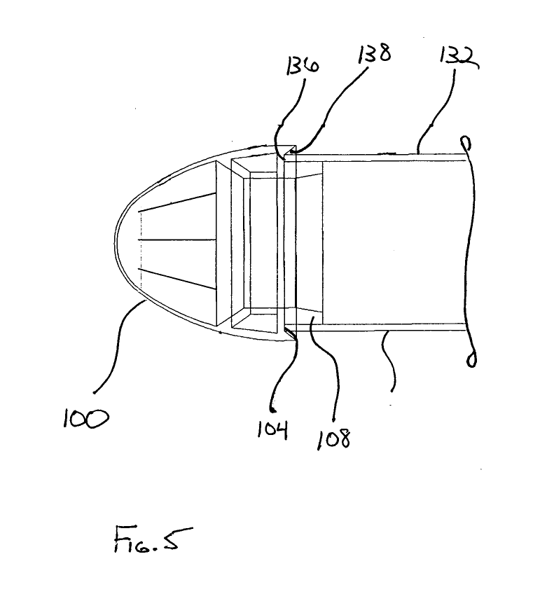

As shown in FIGS. 1 and 2, nose cone body 102 can have a smooth, uninterrupted surface. Alternatively, as illustrated in FIGS. 3 and 4, nose cone body 102 can have a plurality of spaced apart, longitudinal grooves 114 extending from a cone section 116 to an intermediate section 118. Grooves 114 can be formed a variety of ways including scoring of the completed body or molded during production of the nose cone body 102. In an alternative embodiment, grooves 114 can also be molded or scored on an inside surface of nose cone body 102. In addition, when the nose cone body 102 is comprised of a fiber matrix composite, a design incorporating a specific orientation of fibers or fiber binding material creates pre-designed failure areas.

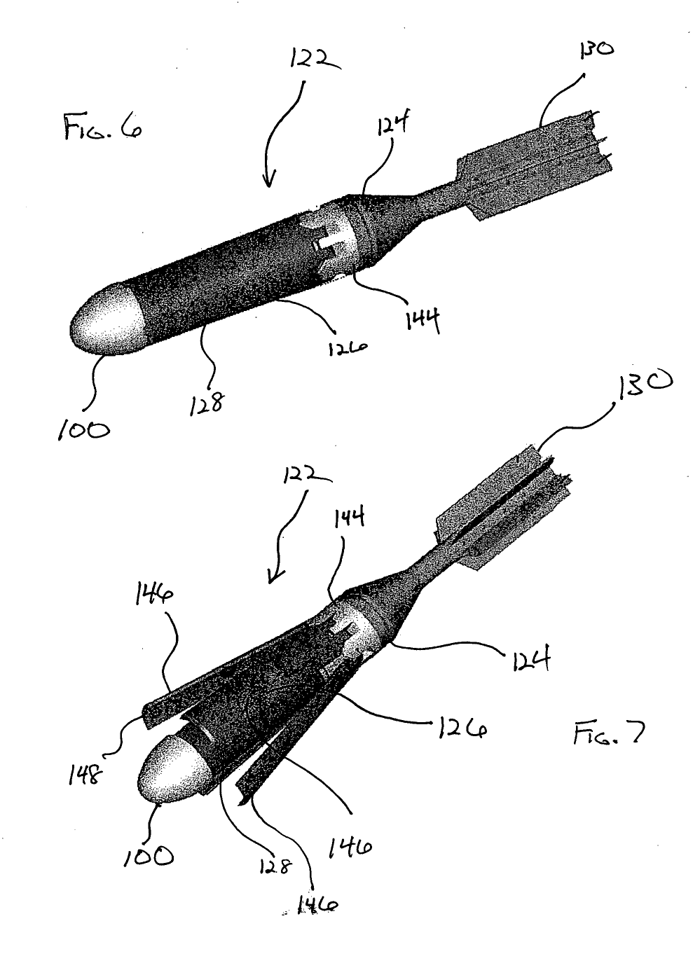

As shown in FIGS. 5, 6, 7, 8, 9 and 10, nose cone 100 is adapted for use in assembling a projectile 122. Generally, projectile 122 comprises features and characteristics representative of a non-lethal projectile design. Typically, projectile 122 comprises a projectile fuselage 124 and a projectile deceleration assembly 126. In a preferred embodiment, projectile deceleration assembly 126 is a wing based system as described in U.S. patent application Ser. No. 10/355,541 entitled “Projectile Kinetic Energy Reduction System” which is commonly assigned to the assignee of the present application and is hereby incorporated by reference in it entirety. Alternatively, projectile deceleration assembly 126 could be selected from parachute based systems and airbrake devices.

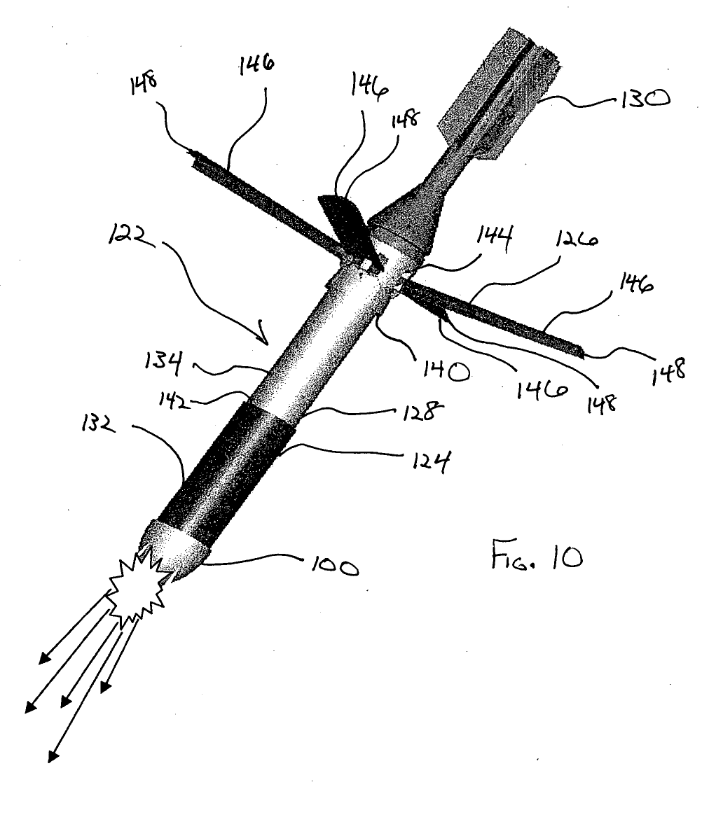

As depicted in FIG. 9, projectile fuselage 124 is comprised of a nose cone 100, a payload body 128 and a tail 130. Payload body 128 includes a forward section 132 and an aft section 134. Forward section 132 of fuselage 124 has an internal diameter dimensioned such that is can slide over and encompass an exterior diameter of aft section 134 as shown in FIGS. 9 and 10. Aft section 134 includes a rear flanged surface 140 to interface with a rear wall 142 of forward section 132. Aft section 134 further includes a wing mounting portion 144 disposed forward of tail 130.

As depicted in FIG. 5, the interior diameter of forward section 132 allows for insertion of the internal projection surface 108 such that abutment ring 104 is in contact with a front wall 136 of forward section 132. Typically, internal projection surface 108 and forward section 132 include mating screw thread attachment means allowing the nose cone 100 to rotatably attach to projectile fuselage 124. When joined, nose cone body 102 extends slightly beyond front wall 136 defining a retaining recess 138 for restraining wing tip 148.

In a preferred embodiment, projectile deceleration assembly 126 comprises a plurality of wings 146 evenly spaced about projectile fuselage 124. Generally, wings 146 are hingedly attached to wing mounting portion 144. Wings 146 include wing tips 148 dimensioned to fit within the retaining recess 138 prior to deployment. In alternative embodiments, projectile deceleration assembly 126 can comprise assemblies which similarly function to quickly decelerate the projectile 122 below lethal velocities of approximately 11 μm/s (24.6 mph). As such, projectile deceleration assembly 126 can comprise a parachute assembly, airbrake devices or other deceleration techniques.

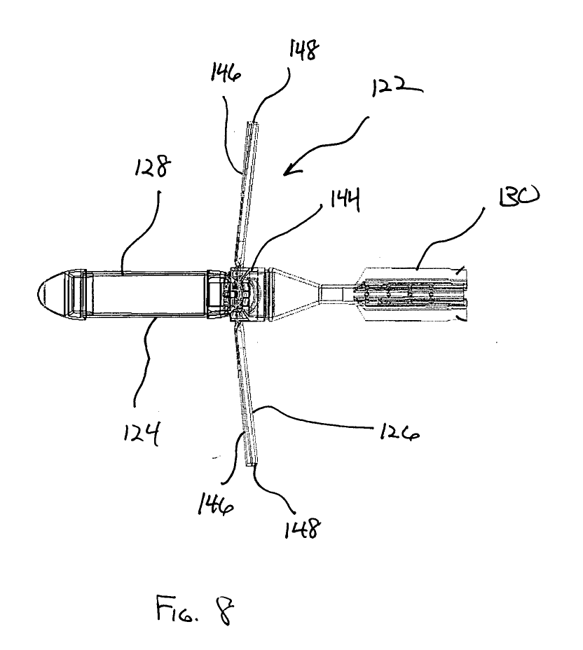

In operation, projectile 122 is most typically configured as a mortar round for use with conventional 81 mm and 120 mm mortars. Once a mortar team has received firing orders, sighted the mortar and been given the order to fire, the projectile 122, as depicted in FIG. 6, is launched. The projectile 122 travels in a ballistic trajectory toward the target.

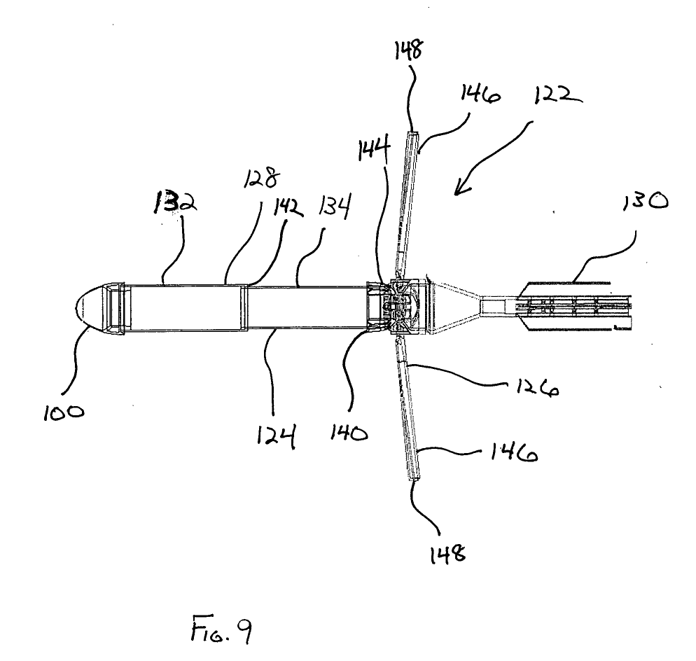

As projectile 122 approaches the target, a deployment charge within fuselage 124 is triggered. The timing of the deployment charge can be based on an internal timer, position information, or uplinked command from a ground or airborne command center. The deployment charge initiates the deceleration of the projectile 122 as shown in FIG. 7. Projectile deceleration assembly 126 extends wings 146 from a stored to a deployed position as shown in FIG. 8 causing projectile 122 to rapidly decelerate from a ballistic trajectory to a free fall trajectory. Wings 146 then begin to spin up due to the free fall velocity in an autogyro mode, creating sufficient drag so that the descent is limited to a non-lethal velocity of less than 11 μm/s (24.6 mph).

As shown in FIG. 9, the combination of forces provided by the deployment charge and full extension of the projectile deceleration assembly 126 causes the payload to be propelled forward through the spaced apart, longitudinal grooves 114 on nose cone 100. The payload ejection sequence occurs rapidly such that the payload is ejected on the same arcuate path of travel as the projectile 122 prior to deployment of the projectile deceleration assembly 126. After the payload has been expelled, projectile 122 falls to the ground at a non-lethal velocity due to the lift characteristics provided by projectile deceleration assembly 126.

Although various embodiments of the present invention have been disclosed here for purposes of illustration, it should be understood that a variety of changes, modifications and substitutions may be incorporated without departing from either the spirit or scope of the present invention.

1. A non-lethal nose cone adapted for use with a projectile having a kinetic energy reduction system, the nose cone comprising:
a nose cone body having a circular cross section, the nose cone body being continuously radiused from a first end comprising a tip to a second end comprising an abutment ring, said nose cone body including a plurality of designed failure areas;
an integral fuze cavity disposed within the nose cone body proximate the abutment ring; and
an internal projection surface having a circular cross-section extending axially from the abutment ring, the internal projection surface having an external diameter less than an internal diameter of a fuselage of the projectile.

2. The non-lethal nose cone of claim 1 wherein the second end of the nose cone body further includes a retaining lip that extends axially aft of the abutment ring, said retaining lip defining an outboard side of a retaining recess so that when the internal projection surface is disposed within the fuselage of the projectile, said fuselage defining an inboard side of the retaining recess.

3. The non-lethal nose cone of claim 1 wherein the plurality of designed failure areas are grooves, said grooves scored or molded into the nose cone body.

4. The non-lethal nose cone of claim 3 wherein the plurality of grooves are present on an external face of the nose cone body.

5. The non-lethal nose cone of claim 3 wherein the plurality of grooves are present on an internal face of the nose cone body.

6. The non-lethal nose cone of claim 1 wherein the plurality of designed failure areas are defined by a composite fiber distribution of the nose cone body.

7. The non-lethal nose cone of claim 1 wherein the internal projection surface of the nose cone body threadably mates with the fuselage of the projectile

8. A projectile for delivering a non-lethal payload, the projectile comprising:
a nose cone including a nose cone body, an internal projection surface, and an integral fuse cavity, said nose cone body having a plurality of designed failure areas;
a projectile body comprising a payload section and a tail section, the payload section having a circular cross-section adapted to receive the internal projection surface of the nose cone, said payload section for storing a non-lethal payload, and
a kinetic energy reduction system coupled to the projectile body.

9. The projectile of claim 8 wherein the integral fuze cavity is disposed about the circumference of the nose cone body so as to maintain an open internal passage between the payload section and the nose cone tip.

10. The projectile of claim 8 wherein the plurality of designed failure areas are a plurality of seams disposed so that upon impact from the payload the nose cone body opens at the plurality of seams to allow passage of the payload.

11. The projectile of claim 10 wherein the plurality of seams are grooves, said grooves scored or molded into the nose cone body.

12. The projectile of claim 11 wherein the plurality of grooves are present on an external face of the nose cone body.

13. The projectile of claim 11 wherein the plurality of grooves are present on an internal face of the nose cone body.

14. The projectile of claim 10 wherein the plurality of seams are defined by a composite fiber distribution of the nose cone body.

15. The projectile of claim 8 wherein the plurality of designed failure areas are disposed so that upon impact from the payload the nose cone body disintegrates into a plurality of particles, said plurality of particles achieving a non-lethal kinetic energy value during a descent.

16. The projectile of claim 8 wherein the kinetic energy reduction system includes a plurality of deployable wings.

17. The projectile of claim 8 wherein the kinetic energy reduction system includes a parachute.

18. A method for delivering a non-lethal payload with a standoff delivery weapon system comprising:
loading a projectile with said non-lethal payload into the standoff delivery weapon system;
delivering the projectile to a location generally above a desired target, the projectile comprising a frangible nose cone coupled to a generally cylindrical payload body and a kinetic energy reduction system, said payload body adapted for carrying a non-lethal munition; and
deploying the kinetic energy reduction system to rapidly decelerate the fall rate of the projectile to below a non-lethal velocity;
releasing the non-lethal payload from its launch position; and
propelling the non-lethal payload through the frangible nose cone.

19. The method of claim 18 wherein the frangible nose cone includes a plurality of designed failure areas.

20. The method of claim 19 wherein the plurality of designed failure areas are grooves, said grooves scored or molded into the nose cone body.

21. The method of claim 20 wherein the plurality of grooves are present on an external face of the nose cone body.

22. The method of claim 20 wherein the plurality of grooves are present on an internal face of the nose cone body.

23. The method of claim 19 wherein the plurality of designed failure areas are defined by a composite fiber distribution of the frangible nose cone.

24. The method of claim 19 wherein the plurality of designed failure areas are disposed so that the frangible nose cone disintegrates into a plurality of particles, said plurality of particles achieving a non-lethal kinetic energy value during a descent.
